(19) United States
(12) Patent Application Publication
(10) Pub. No.: US 2004/0196774 A1
(43) Pub. Date: Oct. 7, 2004

(54) Piezoelectric driving type tracking device and method for fabricating the same

(75) Inventor: Hyo Jin Nam, Seoul (KR)

Correspondence Address: FLESHNER & KIM, LLP, P.O. Box 221200, Chantilly, VA, 20153-1200, US

(73) Assignee: LG Electronics Inc.

(21) Appl. No.: 10/402,934

(22) Filed: Apr. 1, 2003

(51) Int. Cl. G11B 9/00

(52) U.S. Cl. 369/126

(57) ABSTRACT

Piezoelectric driving type tracking device and method for fabricating the same, the device including a tracking object supporting plate for seating and supporting a tracking object, a plurality of first piezoelectric actuators each having one side connected to one of opposite sides of the tracking object supporting plate for moving the tracking object supporting plate in an X direction, a gimbal connected to the other sides of the first piezoelectric actuators for transmitting a force to move the tracking object supporting plate in a Y direction, a plurality of second piezoelectric actuators each having one side connected to the gimbal for moving the tracking object supporting plate in a Y direction, and supporting parts connected to the other sides of the plurality of second piezoelectric actuators for supporting the tracking object supporting plate overhung from the surface, the first and second piezoelectric actuators, and the gimbal, thereby providing a large movement at a low driving voltage, and permitting to fabricate a small sized device, so as to be applicable to the nano-data storage and the nano-tracking device of the AFM principle.

### BACKGROUND OF THE INVENTION

1. Field of the Invention

The present invention relates to a piezoelectric driving type tracking device, and a method for fabricating the same, and more particularly, to a piezoelectric driving type tracking device, and a method for fabricating the same, which can make a large movement by a low driving voltage, and by which a small sized device can be fabricated.

2. Background of the Related Art

In general, a Scanning Probe Microscopy (SPM) is a device for observing a surface form of a specimen by using a micron probe, of which an Atomic Force Microscopy (AFM) is the most widely used, for observing a form of the specimen by measuring an atomic force with a cantilever fabricated by micromachining technology.

The cantilever is fabricated so as to be bent up/down easily even by a micron force, and has a probe with an end pointed to a range of a few atom size at an end thereof, for observing even a surface form of an atomic size.

Recently, researches on nano-lithography devices and nano data storages of the atomic force microscopy principle, rising as the next generation nano-technology, are active. Particularly, the nano data storage rises as a next generation core data storage which can overcome a limitation of recording density of the present hard disk.

The greatest drawback of the nano data storage is a slow response and has no appropriate tracking method developed until now. There is a report that the slow response can be improved by providing array of the cantilevers.

However, there is no appropriate tracking method developed so far.

In general, different from the tracking device of the hard disk, the tracking device of the nano data storage is required to be small, and therefore required to employ micromachining technology for moving the device in an X-axis and a Y-axis directions.

A typical related art tracking device is one that uses a comb-type actuator having an electro static force applied thereto. However, the related art tracking device requires very high driving voltage, has a driver that occupies a relatively large area compared to an area of the recording medium, which is not favorable for fabrication of a small sized tracking device, and has a short distance between electrodes, which is liable to cause an electric short circuit by an external impact.

### SUMMARY OF THE INVENTION

Accordingly, the present invention is directed to a piezoelectric driving type tracking device, and a method for fabricating the same that substantially obviates one or more of the problems due to limitations and disadvantages of the related art.

An object of the present invention is to provide a piezoelectric driving type tracking device, and a method for fabricating the same, which can make a large movement by a low driving voltage, and permits to fabricated a small sized tracking device.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the piezoelectric driving type tracking device includes a tracking object supporting plate for seating and supporting a tracking object, a plurality of first piezoelectric actuators each having one side connected to one of opposite sides of the tracking object supporting plate for moving the tracking object supporting plate in an X direction, a gimbal connected to the other sides of the first piezoelectric actuators for transmitting a force to move the tracking object supporting plate in a Y direction, a plurality of second piezoelectric actuators each having one side connected to the gimbal for moving the tracking object supporting plate in a Y direction, and supporting parts connected to the other sides of the plurality of second piezoelectric actuators for supporting the tracking object supporting plate overhung from the surface, the first and second piezoelectric actuators, and the gimbal, thereby providing a large movement at a low driving voltage, and permitting to fabricate a small sized device, so as to be applicable to the nano-data storage and the nano-tracking device of the AFM principle.

In another aspect of the present invention, there is provided a method for fabricating a piezoelectric driving type tracking device, including a first step of etching uppermost silicon oxide film and silicon thin film of an SOI wafer to form a plurality of first projections, and depositing a lower electrode, a PZT thin film, and an upper electrode in succession, a second step of etching and removing the upper electrode, the PZT thin film, and a lower electrode in succession except opposite sides of the first projections the PZT capacitors are to be formed thereon, and removing the uppermost silicon oxide film and the silicon thin film, to for a plurality of second projections, and a third step of removing a thin film at a bottom of the silicon thin film excluding the second projections in the outermost side region, to float the first and second projections.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a perspective view of a piezoelectric driving type tracking device in accordance with a preferred embodiment of the present invention;

FIG. 2 illustrates a perspective view of a piezoelectric actuator in accordance with a preferred embodiment of the present invention;

FIG. 3 illustrates a plan view of a piezoelectric driving type tracking device in accordance with a preferred embodiment of the present invention;

FIGS. 4A˜4I illustrate sections showing the steps of a method for fabricating a piezoelectric driving type tracking device in accordance with a first preferred embodiment of the present invention;

FIGS. 5A˜5J illustrate sections showing the steps of a method for fabricating a piezoelectric driving type tracking device in accordance with a second preferred embodiment of the present invention;

FIG. 6A˜6D illustrate plan views showing a driving principle of a piezoelectric driving type tracking device of the present invention;

FIG. 7 illustrates a perspective view of a piezoelectric driving type tracking device in accordance with another preferred embodiment of the present invention; and

FIG. 8 illustrates a plan view of a piezoelectric driving type tracking device in accordance with another preferred embodiment of the present invention.

### DETAILED DESCRIPTION OF THE PREFERRED EMBODIMENT

Reference will now be made in detail to the preferred embodiments of the present invention, examples of which are illustrated in the accompanying drawings.

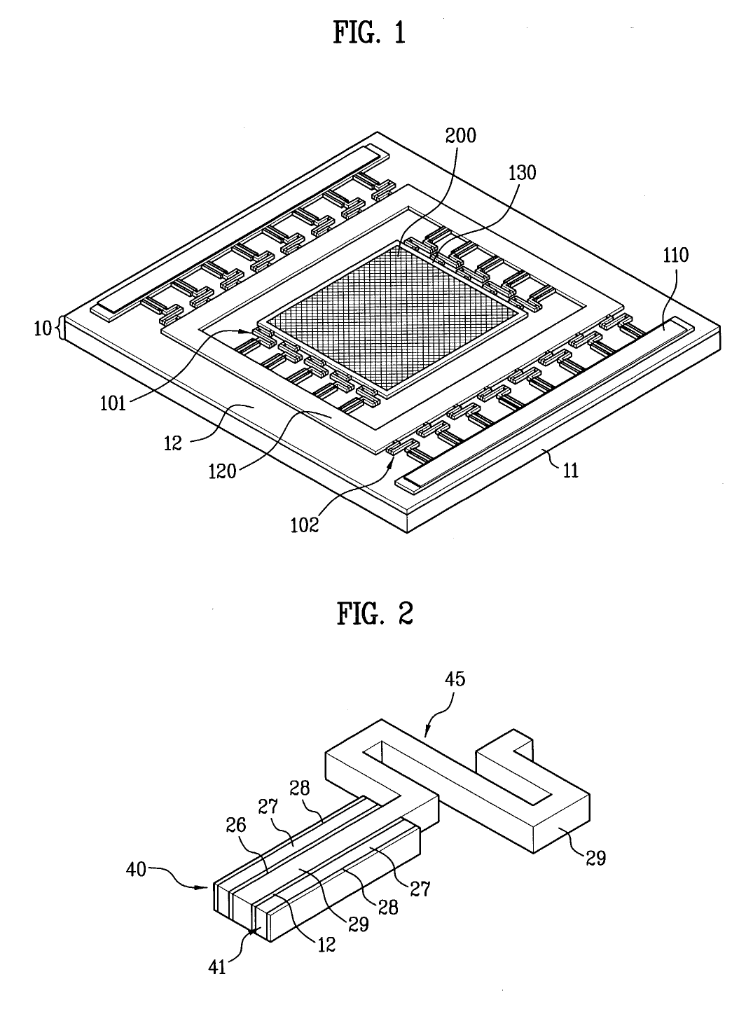

FIG. 1 illustrates a perspective view of a piezoelectric driving type tracking device in accordance with a preferred embodiment of the present invention, including a tracking object supporting plate 130 for seating and supporting a tracking object, a plurality of first piezoelectric actuators 101 each having one side connected to one of opposite sides of the tracking object supporting plate 130 for moving the tracking object supporting plate 130 in an X direction, a gimbal 120 connected to the other sides of the first piezoelectric actuators 101 for transmitting a force to move the tracking object supporting plate 130 in a Y direction, a plurality of second piezoelectric actuators 102 each having one side connected to the gimbal 120 for moving the tracking object supporting plate 130 in a Y direction, and supporting parts connected to the other sides of the plurality of second piezoelectric actuators 102 for supporting the overhung tracking object supporting plate 130, the first and second piezoelectric actuators 101 and 102, and the gimbal 120.

Along with this, the supporting part 110 is supported on a base substrate 10 having a silicon thin film 11 and a silicon oxide film 12 on the silicon thin film 11, and the tracking object supporting plate 130, the first and second piezoelectric actuators 101 and 102, and the gimbal 120 are overhung from the base substrate 10.

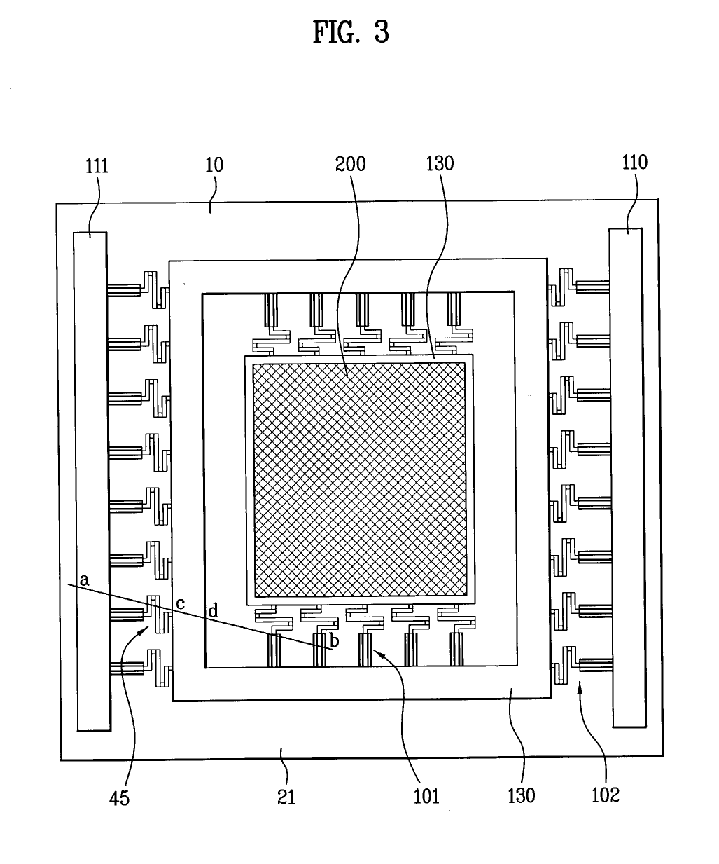

FIG. 2 illustrates a perspective view of a piezoelectric actuator in accordance with a preferred embodiment of the present invention, including PZT capacitors 40 and 41 on opposite sides of a silicon bar 29 each having an upper electrode 28, a PZT (PbZrTiO₃) thin film 27, and a lower electrode 26, and the silicon bar 29 has a meanderline form of connecting part 45 extended therefrom. The meanderline form of connecting part 45 minimizes a mechanical restraining force when the piezoelectric actuator is driven.

FIG. 3 illustrates a plan view of a piezoelectric driving type tracking device in accordance with a preferred embodiment of the present invention, showing the supporting part 110 and 111, the second piezoelectric actuators 102, the gimbal, the first piezoelectric actuators 101, and the tracking object supporting plate 130 connected in succession within the supporting parts 110 and 111 fixed to the base substrate 10, and a tracking object 200 on the tracking object supporting plate 130.

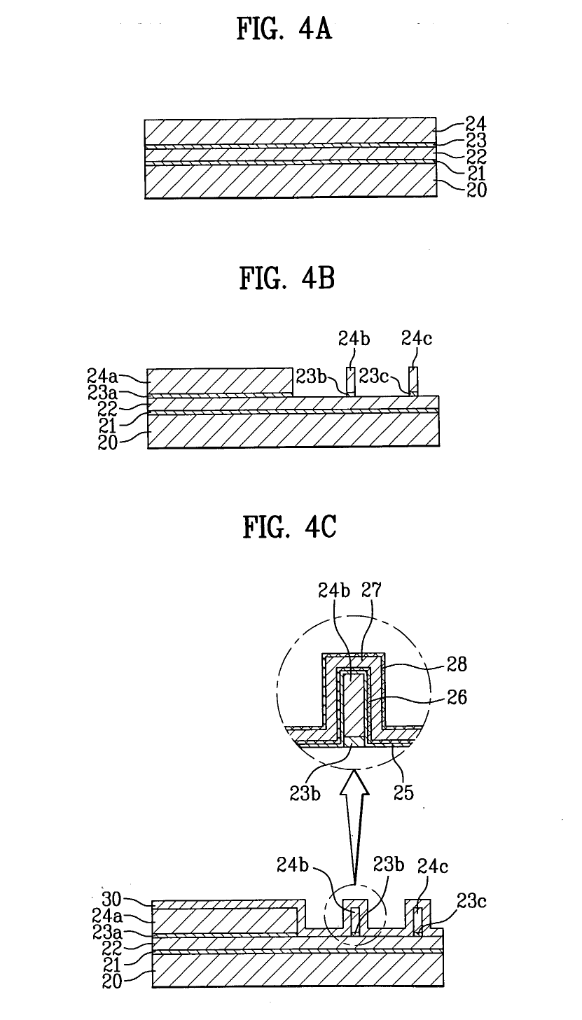

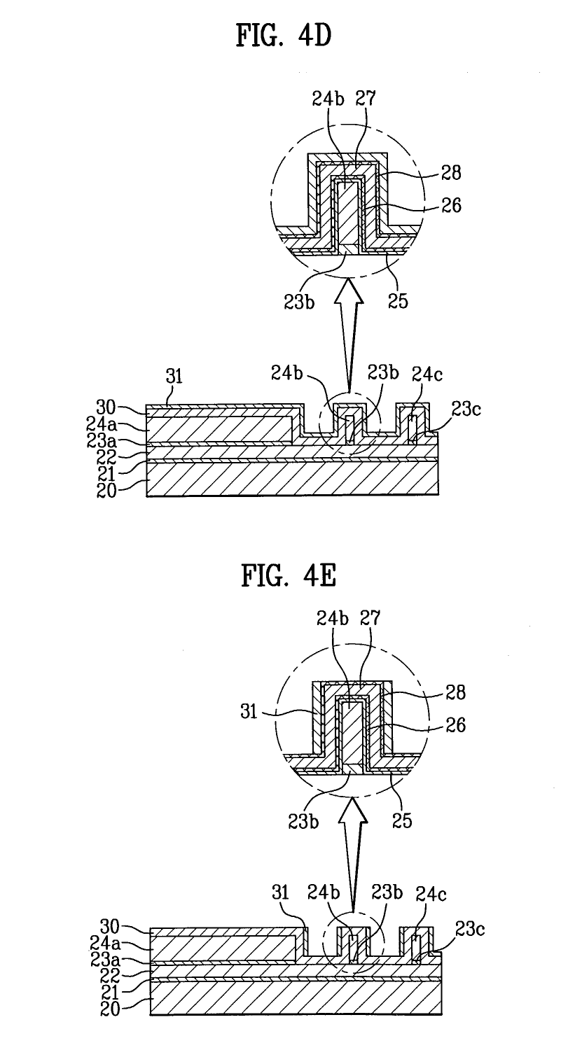

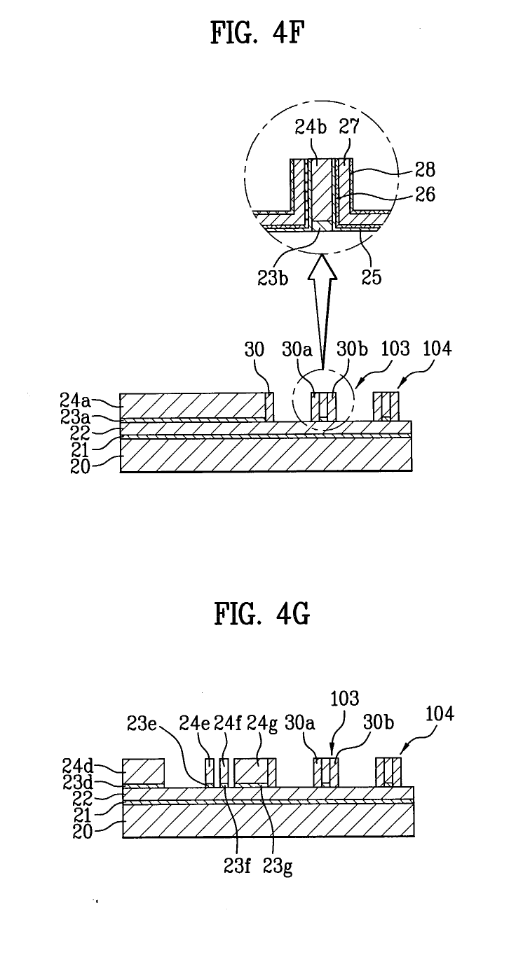

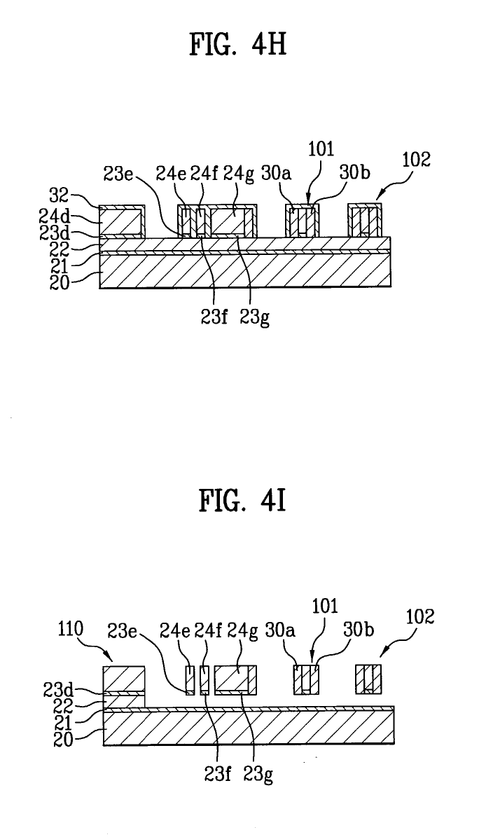

FIGS. 4A˜4T illustrate sections across a line ‘a’-‘b’ in FIG. 3, showing the steps of a method for fabricating a piezoelectric driving type tracking device in accordance with a first preferred embodiment of the present invention.

In the first embodiment method of the present invention, a double SOI wafer as shown in FIG. 4A is used for fabricating the piezoelectric driving type tracking device, which double SOI wafer has a first silicon thin film 20, a first silicon oxide film 21, a second silicon thin film 22, a second silicon oxide film 23 and a third silicon thin film 24.

It is easy for fabrication when the third silicon thin film 24 has thickness of approx. 20 μm, and the second silicon thin film 22 has a thickness of approx. 50 μm.

The second silicon oxide film 23 and the third silicon thin film 24 are etched from an inside region of the double SOI wafer leaving a side region 24a when the double SOI wafer is seen from above, to form first projections on the second silicon thin film 22 for fabricating the piezoelectric actuators, the tracking object supporting plate, and the gimbal. (see FIG. 4B). FIG. 4B illustrates only a part of the ‘a’-‘b’ line in FIG. 3.

In this instance, the silicon is etched by using the Bosch process that has an excellent anisotropic etching performance enough to provide an etching angle of approx. 90°. The Bosch process is a process in which Ion-Coupled Plasma (ICP) etching and Reactive Ion Etching (RIE) mostly in a mixture gas of SF₆ and O₂, and a passivation for an etched side thereof in C₄F₈ gas, are repeated.

Then, for fabricating the PZT capacitor, a third silicon oxide film 25, a lower electrode 26, a PZT thin film 27, and an upper electrode 28 are deposited in succession. (FIG. 4C).

In this instance, the oxide film is deposited by chemical vapor deposition (CVD), and the upper and lower electrodes 28 and 26 are deposited by sputtering or CVD. The electrodes are formed of a metal, such as Pt/Ti, Pt/Ta, or Pt, or an oxide, such as RuO₂ or IrO₂. The PZT thin film 27 is deposited by sputtering or CVD.

Then, a first hard mask layer 31, such as a Cr or Cr/Ti composite thin film, is deposited on the upper electrode 28. (FIG. 4D).

Then, the first hard mask layer 31 is etched except a side region 24a observed from above the double SOI wafer and the first projections the PZT capacitor is to be formed therein. (FIG. 4E).

After the upper electrode 28, the PZT thin film 27, the lower electrode 26, and the silicon oxide film 25 are removed by dry etching in succession with the first hard mask layer 31 used as a mask, and the first hard mask layer 31 is removed. (FIG. 4F)

In this process, a basic structure of the piezoelectric actuators 101 and 102 having the PZT capacitors 30a and 30b are formed.

Next, referring to FIG. 4G, the third silicon thin film 24, and the second silicon oxide film 23 in the side region 24a observed from above the double SOI wafer are selectively removed by Bosch process, to form a plurality of second projections. In this instance, basic structures of connecting parts 24e and 23e, supporting parts 24d and 23d, and gimbals 24g and 23g are formed.

The second projections are the supporting part 111, the connecting part 45 and the gimbal 130 on the line ‘a’-‘d’ in FIG. 3. Moreover, though not shown, after this process, a basic structure of the piezoelectric driving type tracking device, such as the supporting part, the piezoelectric actuators, the connecting parts, the gimbals, and the tracking object supporting plate, and the like, are completed.

Next, though not described in the process drawings, a wiring for supplying power to the completed actuators may be formed by a silicon oxide film deposition, contact hole formation, and metal wiring process.

After the process of FIG. 4G, a second hard mask layer 32 is deposited (FIG. 4H).

Finally, upon removal of the second hard mask layer 32, after removal of the second silicon thin film excluding the projection in the outer most side region observed from above the SOI wafer in X₂F₂ gas after masking with the second hard mask layer 32, the first and second projections are overhung, to completed fabrication of the piezoelectric driving type tracking device in accordance with a first preferred embodiment of the present invention having the piezoelectric actuator, the connecting parts, the gimbals and the tracking object supporting plate overhung from the first silicon oxide film 21. (FIG. 4I).

In this instance, the supporting part 110 is not overhung.

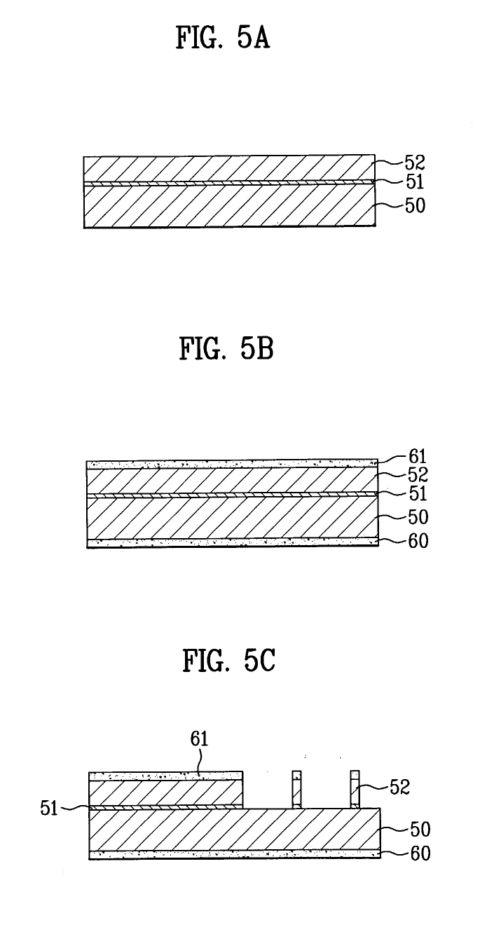

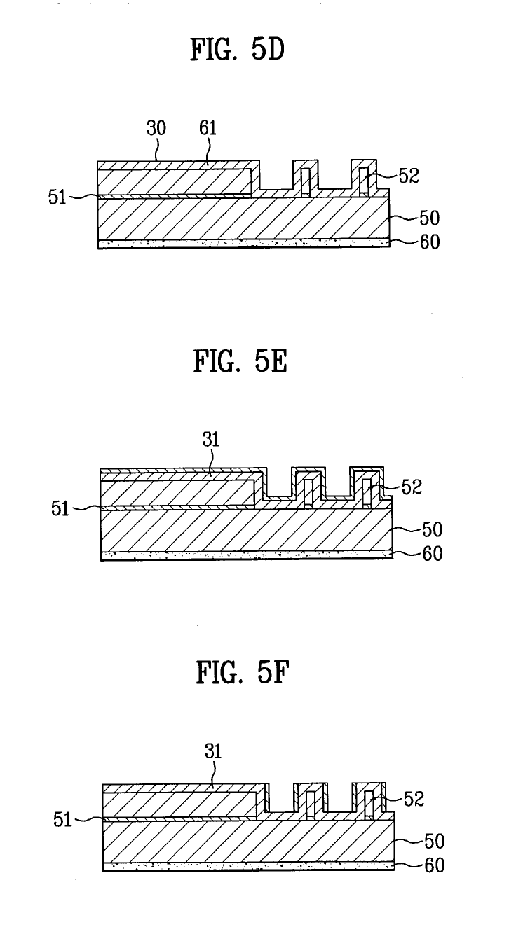

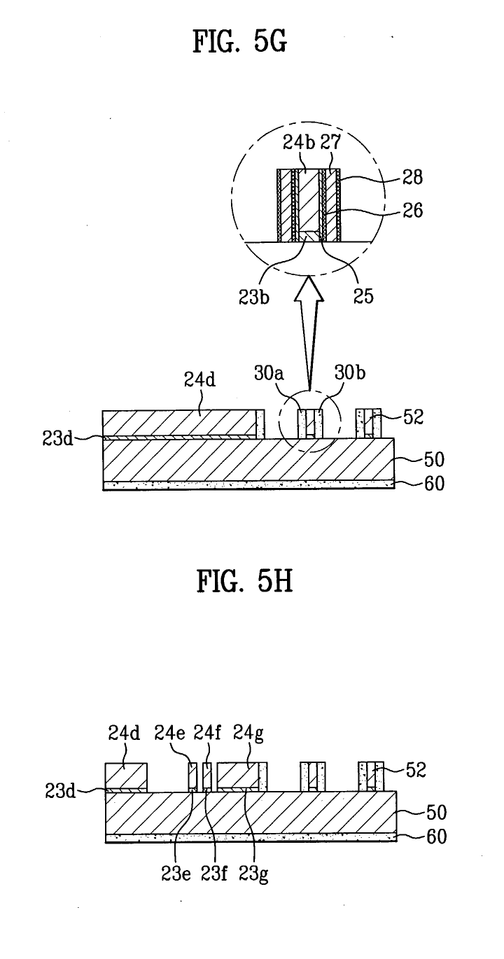

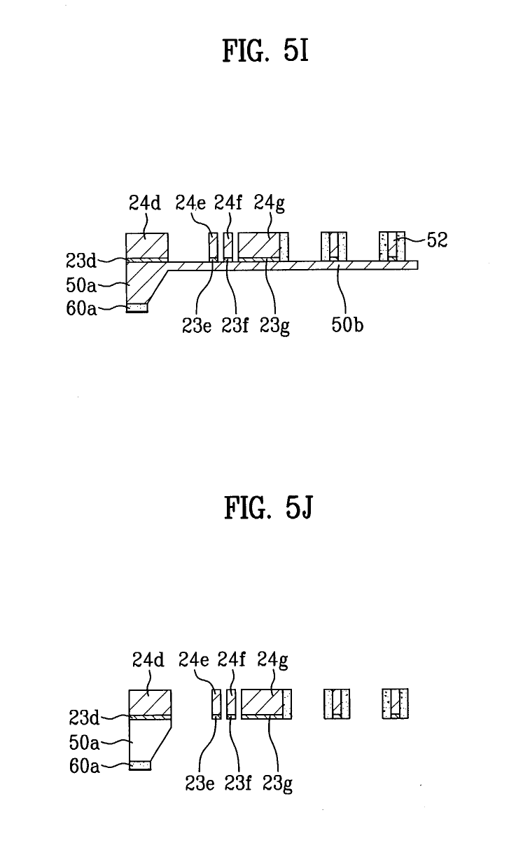

FIGS. 5A˜5J illustrate sections showing the steps of a method for fabricating a piezoelectric driving type tracking device in accordance with a second preferred embodiment of the present invention, wherein in can be noted that an SOI wafer having a first silicon thin film 50, a first silicon oxide film 51, and a second silicon thin film 52 as shown in FIG. 5A is used for fabrication of a piezoelectric driving type tracking device.

First and second silicon nitride films Si₃N₄ are deposited under the first silicon thin film 50 and on the second silicon thin film 52, respectively. (FIG. 5B).

The second silicon nitride film 61 on the second silicon thin film 52 is patterned by photo etching, and the second silicon oxide film 51 and the second silicon thin film 52 in an inside region are etched, leaving a side region observed from above the SOI wafer, with the patterned second silicon nitride film 61 used as a mask. (FIG. 5C).

In this process, the first projections for fabricating the piezoelectric actuator, the tracking object supporting plate, and the gimbals are formed.

Then, the patterned second silicon nitride film 61 is removed. (FIG. 5C).

Thereafter, processes shown in FIGS. 5D˜5H are identical to the processes shown in FIGS. 4C˜4G, according to which processes, basic structures of connecting parts 24e and 23e, and 24f and 23f, supporting parts 24d and 23d, and gimbals 24g and 23g are formed on the first silicon thin film 50 of the SOI wafer as shown in FIG. 5H.

Accordingly, basic structures of the piezoelectric driving type tracking device, such as the supporting part, the piezoelectric actuator, the connecting parts, the gimbals and the tracking object supporting plate, and the like, are formed on the wafer.

Next, of the second projections, the first silicon nitride film is removed excluding the first silicon nitride region 60a under the projections 24d and 23d in an outer most side region observed from above the SOI wafer, and the first silicon thin film is subjected to anisotropic etching with etchant, such as EDP, KOH, and TMAH, down to 20 μm thickness. (FIG. 5I).

Finally, upon removal of a remained first silicon thin film 50b with XeF₂ gas, the actuator, the gimbals and the tracking object supporting plate are overhung, to complete fabrication of the piezoelectric driving type tracking device in accordance with a second preferred embodiment of the present invention. (FIG. 5J).

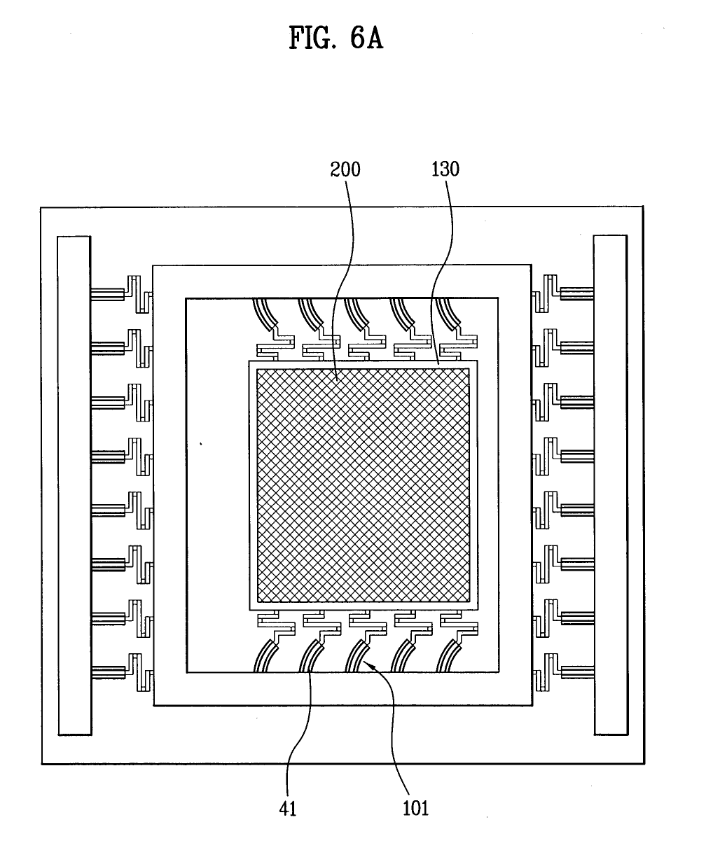

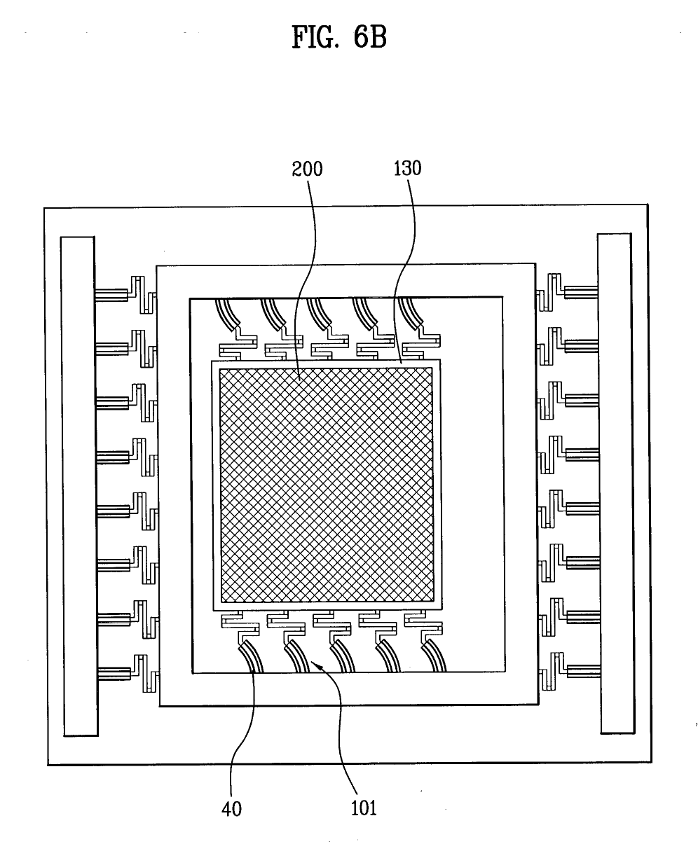

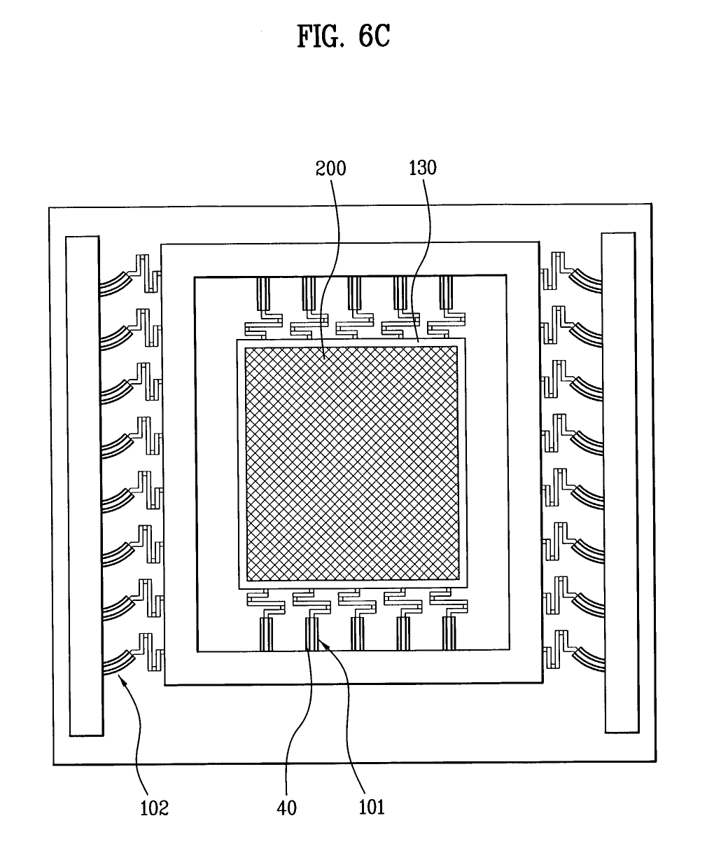

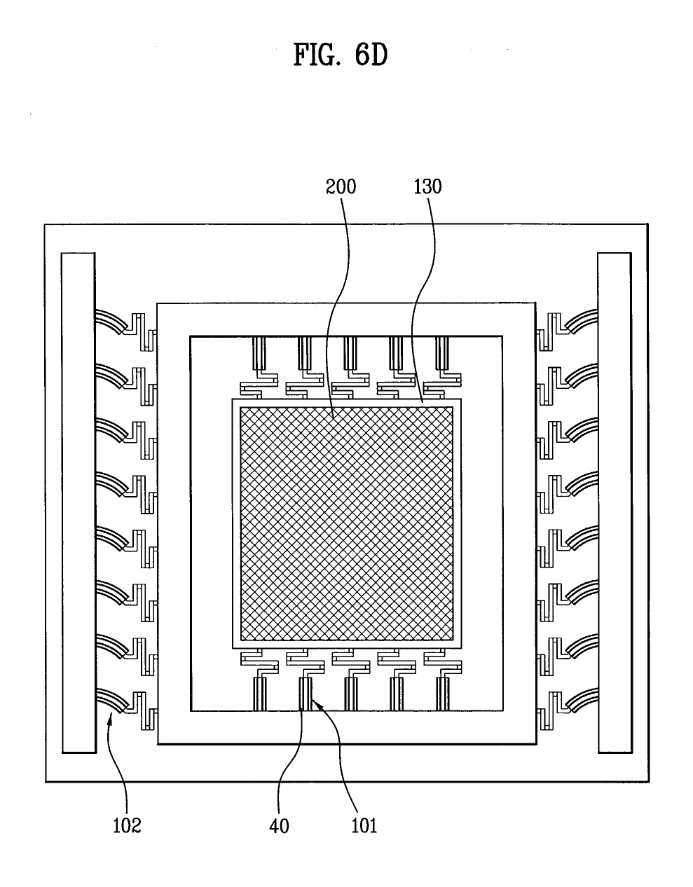

FIG. 6A˜6D illustrate plan views showing a driving principle of a piezoelectric driving type tracking device of the present invention.

Referring to FIG. 6A, a tracking object 200 such as a recoding medium is placed on the tracking object supporting plate 130, and a voltage is provided to the PZT capacitors 41 on a right side of the first piezoelectric actuator 101, to contract the PZT thin films of the first piezoelectric actuators 101 in a length direction, and bend the first piezoelectric actuators 101 in a right direction.

According to this, the tracking object supporting plate 130 and the tracking object 200 connected to the first piezoelectric actuators 101 also move toward the right direction. In this instance, the tracking object supporting plate 130 moves approx. 100 μm from an initial position.

If there is a multi-cantilever head over the tracking object 200, the multi-cantilever head can sense and write a data according to a movement of the tracking object 200.

Referring to FIG. 6B, if a voltage is provided to the PZT capacitors 40 on a left side of the first piezoelectric actuators 101, the first piezoelectric actuators 101 are bent toward a left direction.

Along with this, referring to FIGS. 6C and 6D, a voltage is provided to the PZT capacitors of the second piezoelectric actuators 102 independently, to move the second piezoelectric actuators 102 in up/down direction, thereby moving the tracking object 200 in the up/down directions.

Accordingly, the present invention can provide a large movement at a low driving voltage, and can fabricate a small sized device.

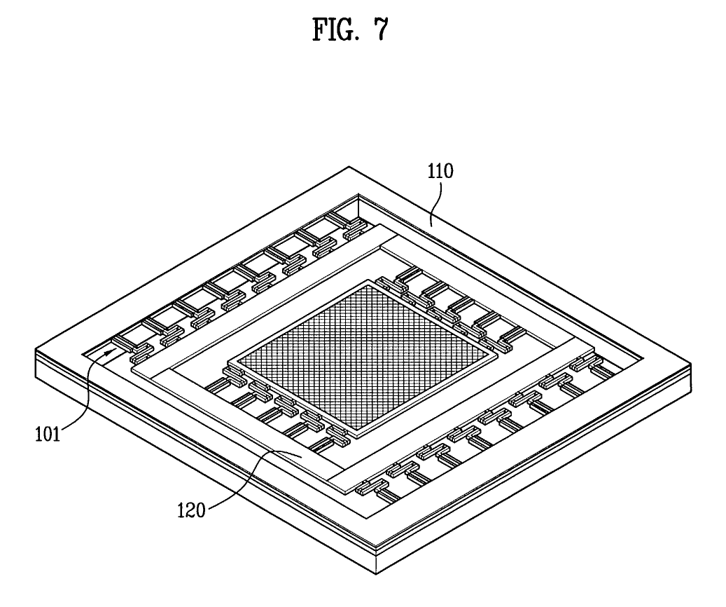

FIG. 7 illustrates a perspective view of a piezoelectric driving type tracking device in accordance with another preferred embodiment of the present invention, wherein the supporting parts connected to the second piezoelectric actuators 102 are formed in a form of a square ring to surround the gimbals 120.

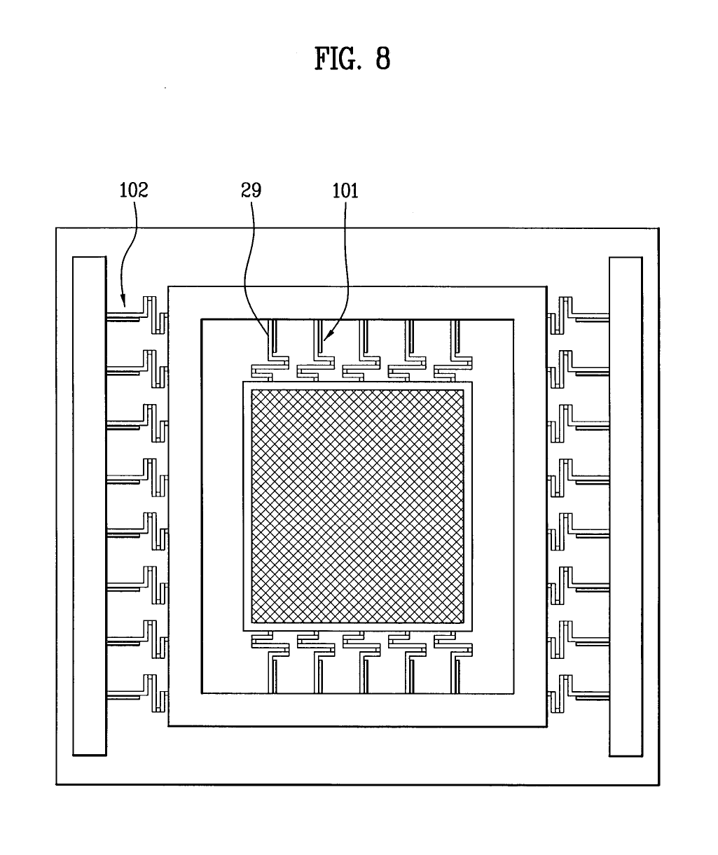

FIG. 8 illustrates a plan view of a piezoelectric driving type tracking device in accordance with another preferred embodiment of the present invention, wherein the PZT capacitors of the first and second piezoelectric actuators 101 and 102 are formed only on one side of the silicon bar 29.

As has been described, since the present invention can provide a large movement at a low driving voltage, and can fabricate a small sized device, the present invention is applicable to the nano-data storage and the nano-tracking device of the AFM principle.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A piezoelectric driving type tracking device comprising:
a tracking object supporting plate for seating and supporting a tracking object;
a plurality of first piezoelectric actuators each having one side connected to one of opposite sides of the tracking object supporting plate for moving the tracking object supporting plate in an X direction;
a gimbal connected to the other sides of the first piezoelectric actuators for transmitting a force to move the tracking object supporting plate in a Y direction;
a plurality of second piezoelectric actuators each having one side connected to the gimbal for moving the tracking object supporting plate in a Y direction; and
supporting parts connected to the other sides of the plurality of second piezoelectric actuators for supporting the tracking object supporting plate overhung from the surface, the first and second piezoelectric actuators, and the gimbal.

2. The device as claimed in claim 1, wherein each of the first and second piezoelectric actuators includes;
a connecting part connected to the tracking object supporting plate or to the supporting part,
a silicon bar connected to the connecting part, and
a PZT capacitor having an upper electrode, a PZT thin film and a lower electrode on one or both sides of the silicon bar.

3. The device as claimed in claim 2, wherein the connecting part has a meanderline form.

4. The device as claimed in claim 1 or 3, wherein the supporting part is fixed to a base substrate.

5. A method for fabricating a piezoelectric driving type tracking device, comprising:
a first step of etching uppermost silicon oxide film and silicon thin film of an SOI wafer to form a plurality of first projections, and depositing a lower electrode, a PZT thin film, and an upper electrode in succession;
a second step of etching and removing the upper electrode, the PZT thin film, and a lower electrode in succession except lateral sides of the first projections the PZT capacitors are to be formed thereon, and removing the uppermost silicon oxide film and the silicon thin film, to for a plurality of second projections; and
a third step of removing a thin film at a bottom of the silicon thin film excluding the second projections in the outermost side region, to float the first and second projections.

6. A method as claimed in claim 5, wherein the first step includes the steps of;
depositing a silicon nitride film Si₃N₄ on the SOI wafer, etching uppermost silicon nitride film, silicon oxide film and silicon thin film, to form a plurality of first projections, and
depositing the lower electrode, the PZT thin film and the upper electrode in succession.
